(19) United States
(12) Patent Application Publication
(10) Pub. No.: US 2022/0258347 A1
(43) Pub. Date: Aug. 18, 2022

(54) TRANSPORT SYSTEM, MOVING METHOD OF OPERATION TARGET AND STORAGE MEDIUM

(71) Applicant: TOYOTA JIDOSHA KABUSHIKI KAISHA, Toyota-shi (JP)

(72) Inventors: Yuta ITOZAWA, Nagoya-shi (JP); Kunihiro IWAMOTO, Nagakute-shi (JP); Hirotaka KOMURA, Tokyo (JP); Yutaro TAKAGI, Tokyo (JP)

(73) Assignee: TOYOTA JIDOSHA KABUSHIKI KAISHA, Toyota-shi (JP)

(21) Appl. No.: 17/548,625

(22) Filed: Dec. 13, 2021

(30) Foreign Application Priority Data
Feb. 15, 2021 (JP) 2021-022028

(51) Int. Cl. B25J 9/16; B25J 18/02

(52) U.S. Cl. CPC B25J 9/1664; B25J 18/025; B25J 9/1679; B25J 9/162

(57) ABSTRACT

A transport system is a transport system in which an autonomous mobile robot transports an object. The autonomous mobile robot includes: a mounting portion on which the object is mounted; and a control unit that changes a height of the mounting portion; and an arm of which height is moved as the height of the mounting portion changes.

### CROSS-REFERENCE TO RELATED APPLICATION

This application claims priority to Japanese Patent Application No. 2021-022028 filed on Feb. 15, 2021, incorporated herein by reference in its entirety.

### BACKGROUND

### 1. Technical Field

The present disclosure relates to a transport system, a moving method of an operation target and a storage medium.

### 2. Description of Related Art

A robot provided with an arm is known. For example, Japanese Unexamined Patent Application Publication No. 2008-23639 (JP 2008-23639 A) discloses a robot provided with a loading platform including a traveling portion and an arm mechanism for handling a package. The arm mechanism of the robot includes a package handling portion, a joint portion, an arm connecting block, and an arm holding portion. Then, the height of the package handling portion that is located at the tip of the arm is adjusted by changing the height of the arm connecting block connected to the arm holding portion so as to be vertically movable, and by rotating the joint portion.

### SUMMARY

In the robot described in JP 2008-23639 A, an arm having a dedicated complex structure is adopted for adjusting the height of the package handling portion, which increases the cost of the arm.

The present disclosure has been made in consideration of the above circumstances as the background, and an object of the present disclosure is to change the position of the arm while the cost of the arm of the robot is suppressed.

A first aspect of the present disclosure for achieving the above object is a transport system in which an autonomous mobile robot transports an object. The autonomous mobile robot includes: a mounting portion on which the object is mounted; a control unit that changes a height of the mounting portion; and an arm of which height is moved as the height of the mounting portion changes. According to the transport system, the configuration for controlling the height of the mounting portion is also used to change the height of the arm. Therefore, the arm itself does not need to have a configuration for changing the height, and can be a simple configuration. Therefore, the position of the arm can be changed while the cost of the arm of the robot is suppressed.

According to the first aspect, the control unit may change the height of the mounting portion such that the height of the arm corresponds to a height of an operation target. With the configuration above, the height of the arm can be adjusted to an appropriate height for operating the operation target.

According to the first aspect, the control unit may further control a horizontal relative position of a tip of the arm with respect to the autonomous mobile robot. With this configuration, the horizontal position of the tip of the arm can be adjusted without moving the position of the autonomous mobile robot itself.

According to the first aspect, the arm may include a shaft portion that extends in a horizontal direction and a protruding portion that extends in a direction perpendicular to the shaft portion and is provided at a tip of the shaft portion. With this configuration, the arm can be easily hooked on the operation target such as a handle.

According to the first aspect, the control unit may rotate the protruding portion with the shaft portion as a rotation axis. With this configuration, the protruding portion can be oriented in any direction.

According to the first aspect, the arm may be provided in the mounting portion. With this configuration, the height of the arm can be changed within the same range as a variable range of the height of the mounting portion.

According to the first aspect, the operation target may be a door handle. In this case, the autonomous mobile robot can open and close the door.

A second aspect of the present disclosure is a moving method of an operation target by using an autonomous mobile robot. The autonomous mobile robot includes a mounting portion on which an object is mounted, a control unit that changes a height of the mounting portion, and an arm of which height is moved as the height of the mounting portion changes. The moving method includes: specifying a position of the operation target; controlling the autonomous mobile robot such that a tip of the arm is located at a position corresponding to the operation target; controlling the autonomous mobile robot such that the tip of the arm is hooked on the operation target; and controlling the autonomous mobile robot such that the autonomous mobile robot moves along a moving direction of the operation target.

A third aspect of the present disclosure is a storage medium storing instructions that are executable by one or more processors and that cause the one or more processors to perform functions. The one or more processers are provided with an autonomous mobile robot. The autonomous mobile robot includes a mounting portion on which an object is mounted, a control unit that changes a height of the mounting portion, and an arm of which height is moved as the height of the mounting portion changes. The functions includes: specifying a position of an operation target; controlling the autonomous mobile robot such that a tip of the arm is located at a position corresponding to the operation target; controlling the autonomous mobile robot such that the tip of the arm is hooked on the operation target; and controlling the autonomous mobile robot such that the autonomous mobile robot moves along a moving direction of the operation target.

According to the present disclosure, the position of the arm can be changed while the cost of the arm of the robot is suppressed.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view showing a schematic configuration of an autonomous mobile robot according to an embodiment;

FIG. 2 is a side view showing a schematic configuration of the autonomous mobile robot according to the embodiment;

FIG. 3 is a block diagram showing a schematic system configuration of the autonomous mobile robot according to the embodiment;

FIG. 4A is a plan view of a mounting portion in a state in which the tip of an arm protrudes outward of the mounting portion in the horizontal direction;

FIG. 4B is a plan view of the mounting portion in a state in which the tip of the arm is pulled toward the mounting portion;

FIG. 5 is a block diagram showing an example of the functional configuration of a control device of the autonomous mobile robot according to the embodiment;

FIG. 6 is a flowchart showing an example of a flow of operation of an operation target using an arm by the autonomous mobile robot according to the embodiment;

FIG. 7 is a schematic view showing an example in which a position of the arm of the autonomous mobile robot according to the embodiment is located at a position corresponding to a height of the operation target;

FIG. 8A is a schematic view of opening a door that is a hinged door, as viewed from above;

FIG. 8B is a schematic view of opening a door that is a hinged door, as viewed from above;

FIG. 9A is a schematic view of opening a door that is a sliding door, as viewed from above; and

FIG. 9B is a schematic view of opening a door that is a sliding door, as viewed from above.

### DETAILED DESCRIPTION OF EMBODIMENTS

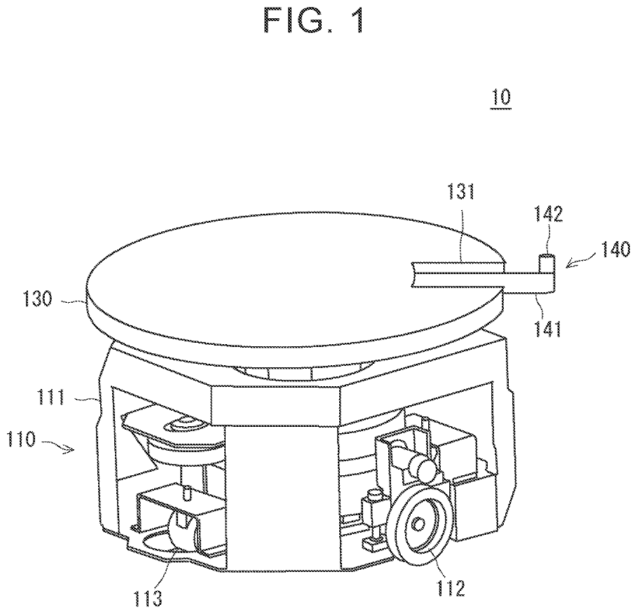

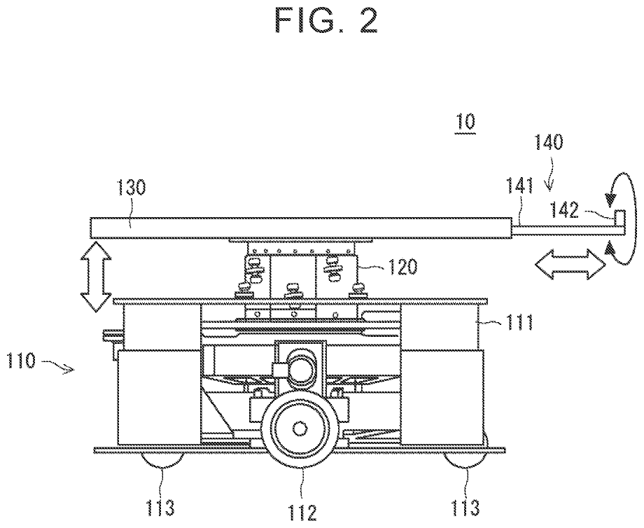

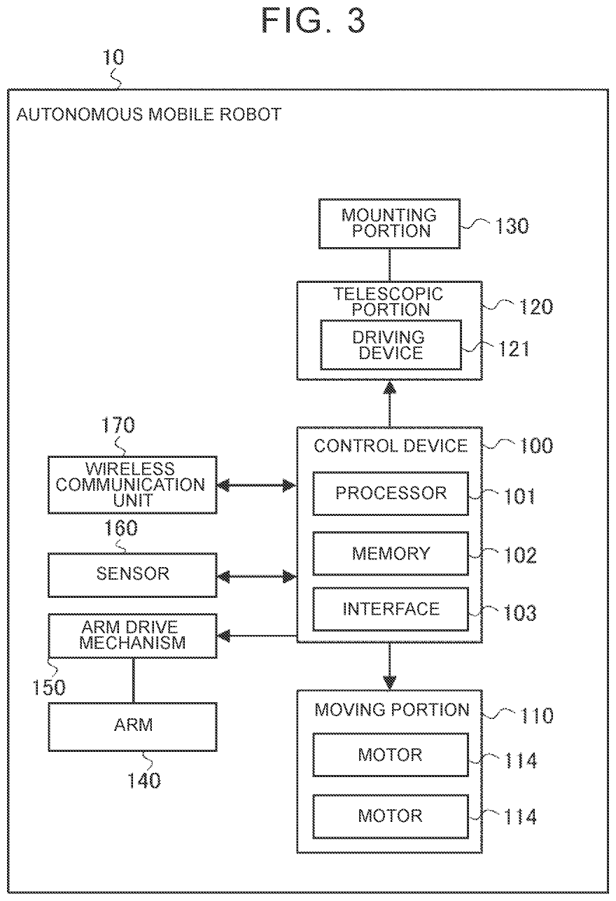

Hereinafter, embodiments of the present disclosure will be described with reference to the drawings. FIG. 1 is a perspective view showing a schematic configuration of an autonomous mobile robot 10 according to the present embodiment. FIG. 2 is a side view showing a schematic configuration of the autonomous mobile robot 10 according to the present embodiment. FIG. 3 is a block diagram showing a schematic system configuration of the autonomous mobile robot 10 according to the present embodiment.

The autonomous mobile robot 10 according to the present embodiment is a robot that autonomously moves in a moving environment such as a house, a facility, a warehouse, a factory, or an outdoor environment, and may belong to a transport system in which the autonomous mobile robot 10 supports and transports an object. The autonomous mobile robot 10 according to the present embodiment includes a moving portion 110 that is movable, a telescopic portion 120 that expands and contracts in the vertical direction, a mounting portion 130 for supporting a mounted object, an arm 140, an arm drive mechanism 150, a control device 100 that controls the autonomous mobile robot 10, including control of the moving portion 110, the telescopic portion 120, and the arm 140, a sensor 160, and a wireless communication unit 170.

The moving portion 110 includes a robot body 111, a pair of right and left drive wheels 112 and a pair of front and rear driven wheels 113 that are rotatably provided for the robot body 111, and a pair of motors 114. The motors 114 drive the respective drive wheels 112. Each motor 114 rotates the corresponding drive wheel 112 via a speed reducer or the like. Each motor 114 rotates the corresponding drive wheel 112 in accordance with a control signal from the control device 100, thereby enabling forward movement, backward movement, and rotation of the robot body 111. With this configuration, the robot body 111 can move to an arbitrary position. The configuration of the moving portion 110 is an example, and the present disclosure is not limited to this. For example, the number of the drive wheels 112 and the driven wheels 113 of the moving portion 110 may be arbitrary, and a known configuration can be applied as long as the robot body 111 can be moved to an arbitrary position.

The telescopic portion 120 is a telescopic mechanism that expands and contracts in the vertical direction. The telescopic portion 120 may be configured as a telescopic type expansion and contraction mechanism. The mounting portion 130 is provided at the upper end of the telescopic portion 120, and the mounting portion 130 is raised or lowered by the operation of the telescopic portion 120. The telescopic portion 120 includes a driving device 121 such as a motor, and expands and contracts as the driving device 121 is driven. That is, the mounting portion 130 is raised or lowered as the driving device 121 is driven. The driving device 121 is driven in response to a control signal from the control device 100. Note that, in the autonomous mobile robot 10, any known mechanism for controlling the height of the mounting portion 130 provided on the upper side of the robot body 111 may be used instead of the telescopic portion 120.

The mounting portion 130 is provided in an upper portion (at the tip) of the telescopic portion 120. The mounting portion 130 is lifted and lowered by the driving device 121 such as a motor. In the present embodiment, the mounting portion 130 is used for loading the object to be transported by the autonomous mobile robot 10 and supporting and lifting the object. In order to transport the object, the autonomous mobile robot 10 moves together with the object while the object is supported by the mounting portion 130. With this configuration, the autonomous mobile robot 10 transports the object. The autonomous mobile robot 10 may enter a space of an object having the space below (for example, furniture such as a cabinet with legs, a chair, a table, and a shelf with legs), lift the object from below using the mounting portion 130, and move together with the object while the mounting portion 130 supports the object. Note that, the autonomous mobile robot 10 may not necessarily move during transportation by the autonomous mobile robot 10. That is, transportation may be movement of the object in the vertical direction by lifting and lowering the mounting portion 130.

The mounting portion 130 includes, for example, a plate material serving as an upper surface and a plate material serving as a lower surface. A space for accommodating the arm 140 and the arm drive mechanism 150 is provided between the upper surface and the lower surface. In the present embodiment, the shape of the plate materials, that is, the shape of the mounting portion 130 is, for example, a flat disk shape, but any other shape may be used. More specifically, in the present embodiment, the mounting portion 130 is provided with a cutout 131 along a line of flow of the arm 140 such that, when the arm 140 is moved, a protruding portion 142 of the arm 140 does not interfere with the mounting portion 130. The cutout 131 is provided at least on the upper surface of the mounting portion 130.

The mounting portion 130 is provided with the arm 140 that is horizontally moved in and out of the mounting portion 130. The arm 140 is a rod-shaped arm having no joints. Specifically, the arm 140 includes a shaft portion 141 extending in the horizontal direction and the protruding portion 142 that extends in the direction perpendicular to the shaft portion 141 and is provided at the tip of the shaft portion 141. That is, in the present embodiment, the arm 140 has an L-shape. Further, the mounting portion 130 is provided with the arm drive mechanism 150 that moves the arm 140 in the horizontal direction (that is, the direction along the shaft portion 141, in other words, the longitudinal direction of the arm 140) and rotates around the shaft portion 141, based on the control signal received from the control device 100. The arm drive mechanism 150 includes, for example, a motor and a linear guide, and moves the arm 140 in the horizontal direction and rotates the shaft portion 141. However, as the arm drive mechanism 150, a known mechanism for performing the operations above may be used.

As described above, the arm 140 is movable in the horizontal direction, and the protruding portion 142 is rotatable as the shaft portion 141 rotates. That is, the protruding portion 142 is rotatable with the shaft portion 141 as the rotation axis. In the present embodiment, the configuration for controlling the height of the mounting portion 130 is also used for changing the height of the arm 140. Therefore, the arm 140 itself does not include a configuration for changing the height of the tip of the arm 140.

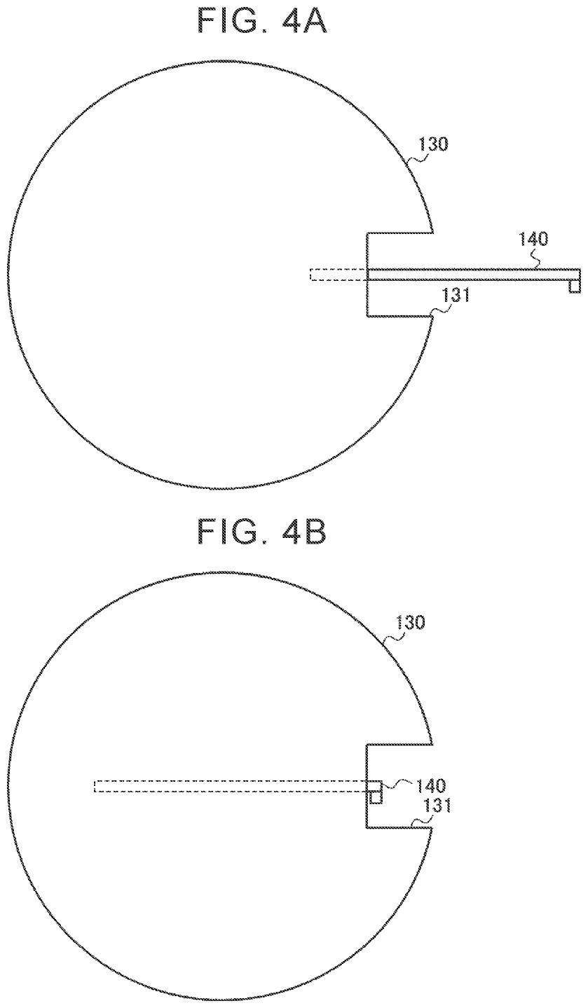

Here, the horizontal movement of the arm 140 is shown in the drawings. FIG. 4A is a plan view of the mounting portion 130 in a state in which the tip of the arm 140 protrudes outward of the mounting portion 130 in the horizontal direction. Further, FIG. 4B is a plan view of the mounting portion 130 in a state in which the tip of the arm 140 is pulled toward the mounting portion 130. As shown in the drawings, the cutout 131 of the mounting portion 130 is a cutout having a predetermined length extending from the outer peripheral end of the mounting portion 130 along the axis of the arm 140. Specifically, for example, as shown in FIG. 4B, the position of the end of the cutout 131 corresponds to the position of the tip (protruding portion 142) of the arm 140 when the arm 140 is most pulled toward the mounting portion 130. As described above, the mounting portion 130 has the cutout 131. Therefore, the protruding portion 142 of the arm 140 can be pulled in to the inside of the outer circumference of the mounting portion 130.

In the present embodiment, when the protruding portion 142 faces upward, the operation of the arm 140 is hindered without the cutout 131. Therefore, the cutout 131 is provided. However, when the operation of the arm 140 is not hindered, the cutout 131 may not be provided.

The sensor 160 is installed at an arbitrary position of the autonomous mobile robot 10 and is a sensor that detects an operation target of the arm 140. For example, the sensor 160 may be a camera. The output of the sensor 160 is input to the control device 100.

The wireless communication unit 170 is a circuit for performing wireless communication to communicate with a server or another robot as needed, and includes, for example, a wireless transmission and reception circuit and an antenna. Note that, when the autonomous mobile robot 10 does not communicate with other devices, the wireless communication unit 170 may be omitted.

The control device 100 is a device that controls the autonomous mobile robot 10, and includes a processor 101, a memory 102, and an interface 103. The processor 101, the memory 102, and the interface 103 are connected to each other via a data bus or the like.

The interface 103 is an input and output circuit used for communicating with other devices such as the moving portion 110, the telescopic portion 120, the arm drive mechanism 150, and the wireless communication unit 170.

The memory 102 is composed of, for example, a combination of a volatile memory and a non-volatile memory. The memory 102 is used to store software (computer program) including one or more commands to be executed by the processor 101, data used for executing various processes of the autonomous mobile robot 10, and the like.

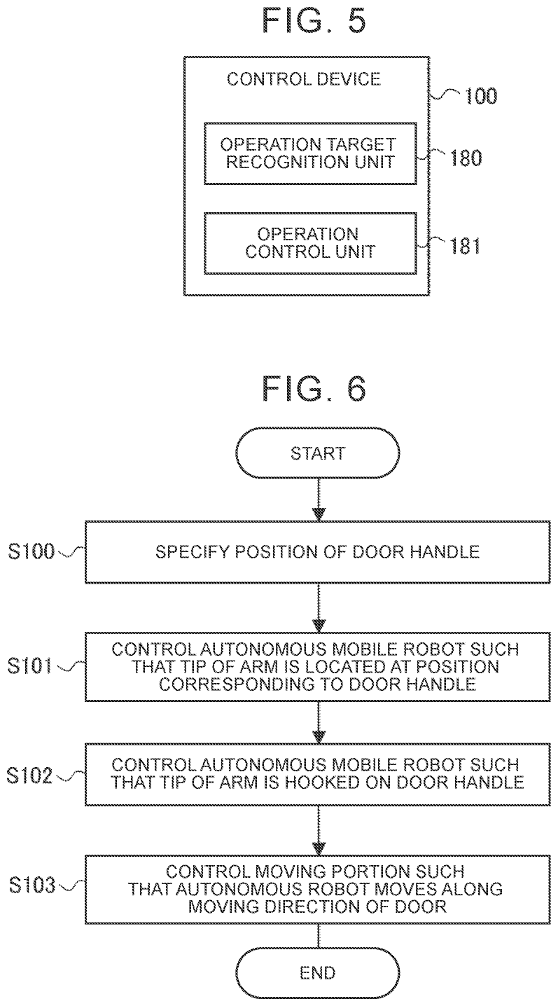

The processor 101 reads software (computer program) from the memory 102 and executes the software to execute processes of each component shown in FIG. 5, which will be described later. Specifically, the processor 101 executes the processes of an operation target recognition unit 180 and an operation control unit 181.

The processor 101 may be, for example, a microprocessor, a microprocessor unit (MPU), or a central processing unit (CPU). The processor 101 may include a plurality of processors. As described above, the control device 100 is a device that functions as a computer.

The above-mentioned program can be stored and supplied to a computer using various types of non-transitory computer-readable media. The non-transitory computer-readable media include various types of tangible recording media. Examples of the non-transitory computer-readable media include magnetic recording media (e.g. flexible disks, magnetic tapes, hard disk drives), magneto-optical recording media (e.g. magneto-optical disks), compact disc read-only memory (CD-ROM), compact disc recordable (CD-R), compact disc rewritable (CD-R/W), and semiconductor memory (e.g. mask ROM, programmable ROM (PROM), erasable PROM (EPROM), flash ROM, random access memory (RAM)). Further, the program may be supplied to the computer using various types of transitory computer-readable media. Examples of the transitory computer-readable media include electrical signals, optical signals, and electromagnetic waves. The transitory computer-readable media can supply the program to the computer via a wired communication path such as an electric wire and an optical fiber, or a wireless communication path.

FIG. 5 is a block diagram showing an example of the functional configuration of the control device 100 of the autonomous mobile robot 10. As shown in FIG. 5, the control device 100 includes the operation target recognition unit 180 and the operation control unit 181.

The operation target recognition unit 180 recognizes the operation target of the arm 140. The operation target recognition unit 180 analyzes the output data from the sensor 160 and recognizes the operation target. For example, the operation target recognition unit 180 recognizes the operation target by executing image recognition processing on the image data output from the sensor 160. Specifically, the operation target recognition unit 180 specifies, for example, the type of the operation target and the position of the operation target by recognizing the operation target.

The operation control unit 181 controls the operation of the autonomous mobile robot 10. That is, the operation control unit 181 controls the operations of the moving portion 110, the telescopic portion 120, and the arm 140. The operation control unit 181 can control the rotation of each drive wheel 112 and move the robot body 111 to an arbitrary position by transmitting the control signal to each motor 114 of the moving portion 110. Further, the operation control unit 181 can control the height of the mounting portion 130 by transmitting the control signal to the driving device 121 of the telescopic portion 120. Further, the operation control unit 181 can control the horizontal movement of the arm 140 and rotation of the protruding portion 142 by transmitting the control signal to the arm drive mechanism 150. That is, the operation control unit 181 can control the horizontal relative position of the tip (protrusion portion 142) of the arm 140 with respect to the autonomous mobile robot 10, and can also control the direction of the protruding portion 142.

The operation control unit 181 may control movement of the autonomous mobile robot 10 by executing known control such as feedback control or robust control based on rotation information of the drive wheels 112 detected by rotation sensors provided for the drive wheels 112. Further, the operation control unit 181 may cause the autonomous mobile robot 10 to move autonomously by controlling the moving portion 110 based on information such as distance information detected by a distance sensor such as a camera or an ultrasonic sensor provided for the autonomous mobile robot 10 and map information of the moving environment. Note that, the sensor 160 for detecting the operation target of the arm 140 may be used for sensing the moving environment when the autonomous mobile robot 10 moves.

Further, the operation control unit 181 controls the operation of the autonomous mobile robot 10 based on the recognition result by the operation target recognition unit 180. For example, the operation control unit 181 controls the autonomous mobile robot 10 such that the position of the tip of the arm 140 becomes the position of the operation target. Here, the tip of the arm 140 moves to an arbitrary position on the horizontal plane as the autonomous mobile robot 10 itself moves. Further, the tip of the arm 140 moves to an arbitrary position in the perpendicular direction as the height of the mounting portion 130 is changed. Then, the tip of the arm 140 moves to an arbitrary position in the horizontal direction by moving the arm 140 in the horizontal direction, that is, by moving the arm 140 in and out. Therefore, the operation control unit 181 controls the operation of at least one of the moving portion 110, the telescopic portion 120, and the arm 140 such that the tip of the arm 140 is located at the position of the operation target. As described above, the tip of the arm 140 can be moved to an arbitrary position on the horizontal plane as the autonomous mobile robot 10 itself moves. Therefore, the horizontal movement of the arm 140, that is, the movement of the arm 140 in and out, may be omitted when such movements are not required during the operation.

Further, the operation control unit 181 controls the operation of the autonomous mobile robot 10 for operating the operation target using the arm 140. For example, the operation control unit 181 may execute control to perform operation such that the tip (protruding portion 142) of the arm 140 is hooked on a door handle (operation target) so as to open and close a door, or may execute control to cause the moving portion 110 to travel in a state in which the tip of the arm 140 hooked on the door handle. Further, the operation control unit 181 may execute control such that a button for operating another device (for example, an elevator button) is pushed with the tip of the arm 140. Further, the operation control unit 181 may execute control such that the protruding portion 142 of the arm 140 is hooked on the bottom surface of the transport target object and the object is delivered between the mounting portion 130 and a rack or the like.

As described above, in the present embodiment, the position of the arm 140 can be changed to an arbitrary position without moving the arm 140 itself three-dimensionally. In particular, in the present embodiment, the configuration for controlling the height of the mounting portion 130 is diverted for changing the height of the arm 140. That is, the operation control unit 181 may control the telescopic portion 120 to lift and lower the object on the mounting portion 130, or may control the telescopic portion 120 to change the height of the arm 140. Therefore, according to the present embodiment, the arm 140 itself does not need to include a configuration for changing the height. That is, the operation target at an arbitrary position can be operated using the arm 140 having a simple structure without using an advanced manipulator provided with joints.

Next, an example of the flow of operation of the operation target using the arm 140 by the autonomous mobile robot 10 will be described with reference to a specific example using a flowchart. FIG. 6 is a flowchart showing an example of the flow of operation of the operation target using the arm 140 by the autonomous mobile robot 10. Here, the operation target is the door handle, and the flow of opening the door by the autonomous mobile robot 10 will be described.

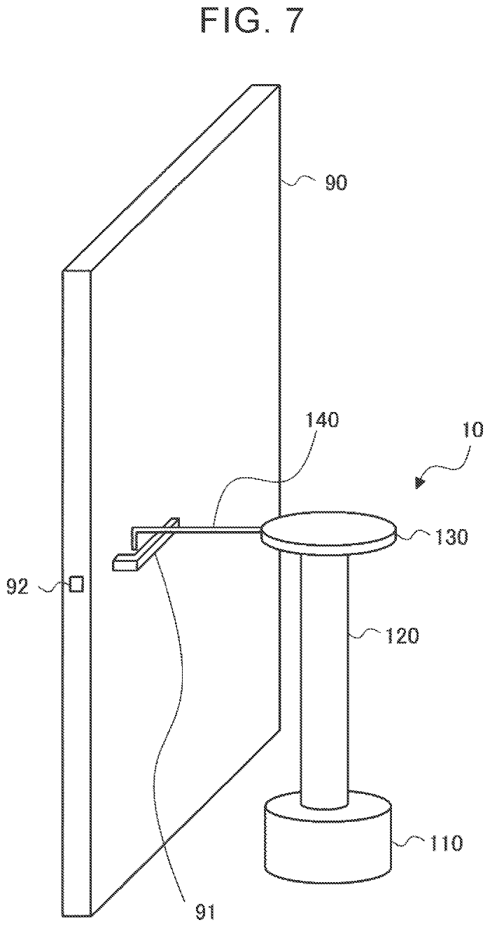

In step S100, the operation target recognition unit 180 executes a process of recognizing the operation target of the arm 140. Here, the operation target recognition unit 180 specifies the position of a handle 91 (see FIG. 7) of a door 90. Note that, the operation target recognition unit 180 may further identify whether the operation target is the handle of a hinged door or the handle of a sliding door.

Next, in step S101, the operation control unit 181 controls the autonomous mobile robot 10 such that the tip of the arm 140 is located at the position corresponding to the handle 91 of the door 90. In particular, as shown in FIG. 7, the operation control unit 181 controls the height of the mounting portion 130 such that the height of the arm 140 (the height of the tip of the arm 140) corresponds to the handle 91 of the door 90. That is, the operation control unit 181 controls the telescopic portion 120 such that the height of the arm 140 becomes the height corresponding to the handle 91 of the door 90. Note that, the operation control unit 181 may control the moving portion 110 or the arm 140 such that the position of the tip of the arm 140 is located at the position corresponding to the handle 91 of the door 90, instead of controlling the telescopic portion 120.

Next, in step S102, the operation control unit 181 controls the autonomous mobile robot 10 such that the tip (protruding portion 142) of the arm 140 is hooked on the handle 91 of the door 90. For example, the operation control unit 181 may hook the protruding portion 142 on the handle 91 by rotating the protruding portion 142, hook the tip of the arm 140 on the handle 91 by changing the height of the arm 140, or hook the tip of the arm 140 on the handle 91 by moving the position of the arm 140 in the horizontal plane.

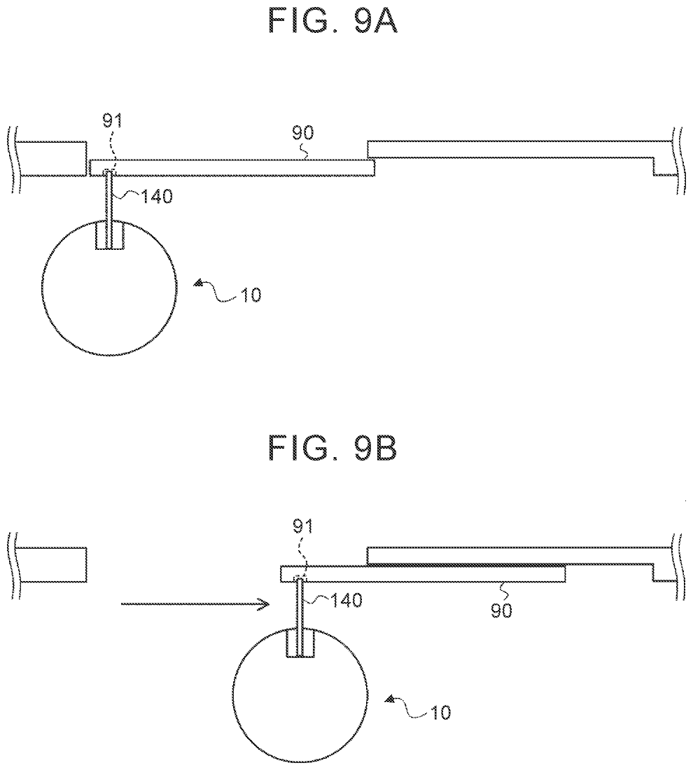

Note that, in the example shown in FIG. 7, the handle 91 is a bar extending in the horizontal direction. However, the shape of the handle 91 is not limited to this. For example, the handle 91 may be a bar extending in the perpendicular direction. Further, when the door is a sliding door, the handle 91 may be a hole provided in the door (see FIGS. 9A and 9B).

Further, as shown in FIG. 7, when the door 90 is provided with a latch bolt 92, the operation control unit 181 may pull the latch bolt 92 into the door 90 by pushing down the handle 91 that is a lever handle. In this case, the operation control unit 181 may push down the lever handle by, for example, moving the arm 140 that is located above the lever handle downward through the control of the telescopic portion 120.

Next, in step S103, the operation control unit 181 controls the moving portion 110 such that the autonomous mobile robot 10 moves along the moving direction of the door 90.

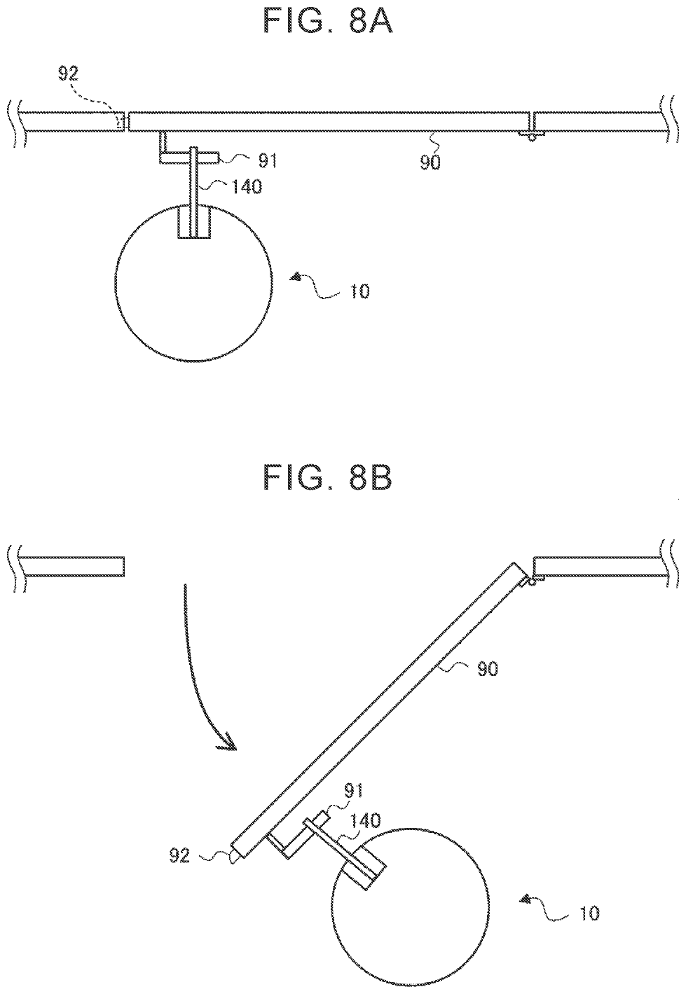

FIGS. 8A and 8B are schematic views of how the autonomous mobile robot 10 opens the door 90 that is a hinged door, as viewed from above. FIG. 8A shows a state when the process in step S102 is executed, and FIG. 8B shows a state when the process in step S103 is executed. As shown in FIGS. 8A and 8B, when the door 90 is a hinged door, the operation control unit 181 controls the autonomous mobile robot 10 to move so as to draw an arc. With this process, the door 90 that is a hinged door opens.

FIGS. 9A and 9B are schematic views of opening the door 90 that is a sliding door, as viewed from above. FIG. 9A shows a state when the process in step S102 is executed, and FIG. 9B shows a state when the process in step S103 is executed. As shown in FIGS. 9A and 9B, when the door 90 is a sliding door, the operation control unit 181 controls the autonomous mobile robot 10 to move in parallel to the direction in which the door 90 is opened and closed. With this process, the door 90 that is a sliding door is opened.

The autonomous mobile robot 10 can open the door by executing the processes in the steps described above. Note that, the autonomous mobile robot 10 may control the moving portion 110 so as to pass through the door after the door is opened.

In the above-mentioned example, the case where the door 90 is opened has been described. However, in step S103, the operation control unit 181 may control the moving portion 110 to close the door 90. Further, the operation control unit 181 may determine the moving direction in step S103 based on the recognition result by the operation target recognition unit 180. For example, when the operation target recognition unit 180 recognizes that the handle as the operation target is the handle of the hinged door in the closed state, the operation control unit 181 may control the autonomous mobile robot 10 to move so as to open the hinged door, as shown in FIGS. 8A and 8B. Similarly, for example, when the operation target recognition unit 180 recognizes that the handle as the operation target is the handle of the sliding door in the closed state, the operation control unit 181 may control the autonomous mobile robot 10 to move so as to open the sliding door, as shown in FIGS. 9A and 9B.

The embodiment has been described as above. As described above, the autonomous mobile robot 10 according to the present embodiment includes the mounting portion 130 for mounting the object, the operation control unit 181 that changes the height of the mounting portion 130, and the arm 140 of which height is moved as the height of the mounting portion 130 is changed. That is, in the present embodiment, the configuration for controlling the height of the mounting portion 130 can also be used for changing the height of the arm 140. Therefore, according to the present embodiment, the arm 140 itself does not need to have a configuration for changing the height, and can be a simple configuration. Therefore, the position of the arm can be changed while the cost of the arm of the robot is suppressed.

Further, the operation control unit 181 changes the height of the mounting portion 130 such that the height of the arm 140 corresponds to the height of the operation target. Therefore, the height of the arm 140 can be adjusted to an appropriate height for operating the operation target. Further, the operation control unit 181 controls the horizontal relative position of the tip of the arm 140 with respect to the autonomous mobile robot 10. Therefore, the horizontal position of the tip of the arm 140 can be adjusted without moving the position of the autonomous mobile robot 10 itself.

Further, the arm 140 includes the protruding portion 142 at the tip of the shaft portion 141. Therefore, the arm 140 can be easily hooked on the operation target such as a handle. Further, the operation control unit 181 can rotate the protruding portion 142. Therefore, the protruding portion 142 can be directed in any direction. Therefore, for example, the direction of the protruding portion 142 can be adjusted to a direction convenient for hooking the arm 140 on the handle. Further, the arm 140 is provided on the mounting portion 130, the height of the arm 140 can be changed within the same range as a variable range of the height of the mounting portion 130.

The present disclosure is not limited to the above embodiments, and can be appropriately modified without departing from the spirit. For example, in the above-described embodiment, the arm 140 is provided inside the mounting portion 130. However, the arm 140 may be provided on the upper surface or the lower surface of the mounting portion 130, or may be provided in a portion of the outer surface of the telescopic portion 120 of which height is changed by operation of the telescopic portion 120. Further, in the above-described embodiment, the protruding portion 142 is provided at the tip of the arm 140. However, the tip of the arm 140 may be a hook or a gripper.

What is claimed is:

1. A transport system in which an autonomous mobile robot transports an object, wherein
the autonomous mobile robot includes:
a mounting portion on which the object is mounted;
a control unit that changes a height of the mounting portion; and
an arm of which height is moved as the height of the mounting portion changes.

2. The transport system according to claim 1, wherein the control unit changes the height of the mounting portion such that the height of the arm corresponds to a height of an operation target.

3. The transport system according to claim 1, wherein the control unit further controls a horizontal relative position of a tip of the arm with respect to the autonomous mobile robot.

4. The transport system according to claim 1, wherein the arm includes a shaft portion that extends in a horizontal direction and a protruding portion that extends in a direction perpendicular to the shaft portion and is provided at a tip of the shaft portion.

5. The transport system according to claim 4, wherein the control unit rotates the protruding portion with the shaft portion as a rotation axis.

6. The transport system according to claim 1, wherein the arm is provided in the mounting portion.

7. The transport system according to claim 2, wherein the operation target is a door handle.

8. A moving method of an operation target by using an autonomous mobile robot, the autonomous mobile robot includes
a mounting portion on which an object is mounted,
a control unit that changes a height of the mounting portion, and
an arm of which height is moved as the height of the mounting portion changes,
the moving method comprising:
specifying a position of the operation target;
controlling the autonomous mobile robot such that a tip of the arm is located at a position corresponding to the operation target;
controlling the autonomous mobile robot such that the tip of the arm is hooked on the operation target; and
controlling the autonomous mobile robot such that the autonomous mobile robot moves along a moving direction of the operation target.

9. A storage medium storing instructions that are executable by one or more processors and that cause the one or more processors to perform functions, wherein the one or more processers are provided with an autonomous mobile robot, and
the autonomous mobile robot includes
a mounting portion on which an object is mounted,
a control unit that changes a height of the mounting portion, and
an arm of which height is moved as the height of the mounting portion changes,
the functions comprising:
specifying a position of an operation target;
controlling the autonomous mobile robot such that a tip of the arm is located at a position corresponding to the operation target;
controlling the autonomous mobile robot such that the tip of the arm is hooked on the operation target; and
controlling the autonomous mobile robot such that the autonomous mobile robot moves along a moving direction of the operation target.
